(19) United States
(12) Patent Application Publication
(10) Pub. No.: US 2023/0292787 A1
(43) Pub. Date: Sep. 21, 2023

(54) WAFFLE CONE CHOCOLATE COATER AND COATING METHOD

(71) Applicant: Kilwins Chocolates Franchise, Inc., Petoskey, MI (US)

(72) Inventors: Joseph Mark Audia, Petoskey, MI (US); Donald Wayne McCarty, Harbor Springs, MI (US); Peter Gallagher Wendland, Harbor Springs, MI (US); Charles H. Cunningham, Alanson, MI (US)

(73) Assignee: Kilwins Chocolates Franchise, Inc., Petoskey, MI (US)

(21) Appl. No.: 18/183,336

(22) Filed: Mar. 14, 2023

Related U.S. Application Data
(60) Provisional application No. 63/321,263, filed on Mar. 18, 2022.

(51) Int. Cl. A23G 9/28; A23G 3/20; A23G 3/34

(52) U.S. Cl. CPC A23G 9/288; A23G 3/2023; A23G 3/343

(57) ABSTRACT

A waffle cone coating assembly is disclosed. The waffle cone coating assembly includes a fountain assembly disposed within a basin. The fountain assembly includes a tube having an upper end spaced from the basin and a nozzle disposed at the upper end of the tube. The nozzle includes a plurality of coating outlets. A flange is disposed below the nozzle and includes a diameter greater than a diameter of the nozzle. A coating material is recirculated from the basin through the plurality of coating outlets and returns to the basin.

### CROSS-REFERENCE TO RELATED APPLICATION

This application claims priority to and the benefit under 35 U.S.C. § 119(e) of U.S. Provisional Application No. 63/321,263, filed on Mar. 18, 2022, entitled “WAFFLE CONE CHOCOLATE COATER AND COATING METHOD,” the disclosure of which is hereby incorporated herein by reference in its entirety.

### TECHNOLOGICAL FIELD

The present disclosure generally relates to a waffle cone coating assembly, and more specifically, to a waffle cone coating assembly including a fountain assembly configured to coat an interior of the waffle cone.

### SUMMARY OF THE DISCLOSURE

According to one aspect of the disclosure, a waffle cone coating assembly includes a cabinet that defines an interior and includes a basin and a fountain assembly disposed within the basin. The fountain assembly includes a tube having an upper end spaced from the basin and a nozzle disposed at the upper end of the tube. The nozzle includes a plurality of coating outlets. A flange is disposed below the nozzle and includes a diameter greater than a diameter of the nozzle. The waffle cone coating assembly is configured to recirculate a coating material from the basin through the plurality of coating outlets and return the coating material to the basin.

According to another aspect of the disclosure, a cone coating machine includes a basin that is configured to contain a liquid. The basin includes a lower interior surface and a fountain assembly disposed within the basin. The fountain assembly includes a tube that has an upper end and a lower end. The lower end is proximate the lower interior surface of the basin. A nozzle is coupled to the upper end of the tube, where the nozzle includes a plurality of coating outlets and further where the waffle cone coating assembly is configured to recirculate a coating material from the basin through the plurality of coating outlets and return the coating material to the basin.

According to yet another aspect of the disclosure, a waffle cone coating nozzle assembly includes a nozzle that comprises an annular sidewall that defines a plurality of side coating outlets, an upper surface that defines at least one upper coating outlet, and a central channel that is fluidly coupled to the plurality of side coating outlets. A plurality of side channels fluidly couple the side coating outlets to at least one central channel, where the plurality of side coating outlets are positioned higher than an interior end of the plurality of side channels and a flange is coupled with a bottom surface of the nozzle. The flange has a diameter greater than a diameter of the nozzle.

A method of coating an interior of a waffle cone includes the steps of recirculating a coating material from a basin through a nozzle including a plurality of coating outlets at a flow rate configured to envelop the nozzle with the coating material, wherein the nozzle is dimensioned to be received within a waffle cone, placing an interior of the waffle cone onto the nozzle, rolling the interior of the waffle cone into contact with the coating material to coat the interior of the waffle cone with the coating material and removing the waffle cone from the nozzle.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is a top perspective view of a waffle cone coating assembly according to various aspects of the present disclosure;

FIG. 2 is a side elevational view of a waffle cone coating assembly according to various aspects of the present disclosure;

FIG. 3 is top plan view of a waffle cone coating assembly according to various aspects of the present disclosure;

FIG. 4 is partial, top perspective view of a waffle cone coating assembly according to various aspects of the present disclosure;

FIG. 5 is a side cross-sectional view of a waffle cone coating assembly taken along line V-V according to various aspects of the present disclosure;

FIG. 6 is a top perspective view of a cabinet for a waffle cone coating assembly according to various aspects of the present disclosure;

FIG. 7 is a side elevational view of a cabinet for a waffle cone coating assembly according to various aspects of the present disclosure;

FIG. 8 is a top plan view of a cabinet for a waffle cone coating assembly according to various aspects of the present disclosure;

FIG. 9 is a side cross-sectional view of a cabinet for a waffle cone coating assembly taken along line IX-IX according to various aspects of the present disclosure;

FIG. 10 is a side cross-sectional view of a cabinet for a waffle cone coating assembly along line X-X according to various aspects of the present disclosure;

FIG. 11 is a side cross-sectional view of a nozzle and flange for a waffle cone coating assembly along line XI-XI according to various aspects of the present disclosure;

FIG. 12A is a is top plan view of a nozzle for a waffle cone coating assembly according to various aspects of the present disclosure;

FIG. 12B is a bottom plan view of a nozzle according to various aspects of the present disclosure;

FIG. 13 is a top perspective view of another waffle cone coating assembly according to various aspects of the present disclosure;

FIG. 14 is a side elevational, cutaway view of a waffle cone coating assembly according to various aspects of the present disclosure;

FIG. 15 is a side cross-sectional view of the waffle cone coating assembly taken along line XV-XV according to various aspects of the present disclosure;

FIG. 16 is top plan view of a waffle cone coating assembly according to various aspects of the present disclosure;

FIG. 17 is a side cross-sectional view of a nozzle and flange for a waffle cone coating assembly taken along line XV-XV according to various aspects of the present disclosure;

FIG. 18 is a side cross-sectional view of yet another waffle cone coating assembly according to various aspects of the present disclosure;

FIG. 19 is a side cross-sectional view of yet another waffle cone coating assembly according to various aspects of the present disclosure;

FIG. 20 is a schematic control diagram of a waffle cone coating assembly according to various aspects of the present disclosure;

FIG. 21A is a front perspective view of a waffle cone prior to interior coating of the waffle cone according to various aspects of the present disclosure;

FIG. 21B is a front perspective view of a waffle cone during coating of an interior of the waffle cone according to various aspects of the present disclosure;

FIG. 21C is a front perspective view of a waffle cone after interior coating of the waffle cone according to various aspects of the present disclosure; and

FIG. 22 is a flow diagram of a method of coating an interior of a waffle cone according to various aspects of the present disclosure.

The components in the figures are not necessarily to scale, emphasis instead being placed upon illustrating the principles described herein.

### DETAILED DESCRIPTION

The present illustrated embodiments reside primarily in combinations of method steps and apparatus components related to a waffle cone coating assembly. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

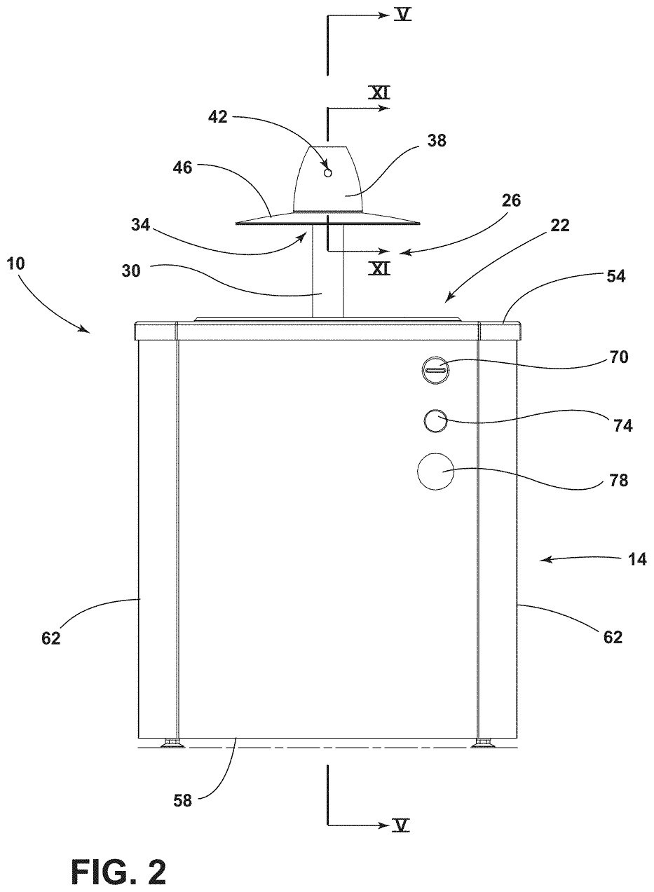

For purposes of description herein, the terms “upper,” “lower,” “right,” “left,” “rear,” “front,” “vertical,” “horizontal,” and derivatives thereof shall relate to the disclosure as oriented in FIG. 2. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

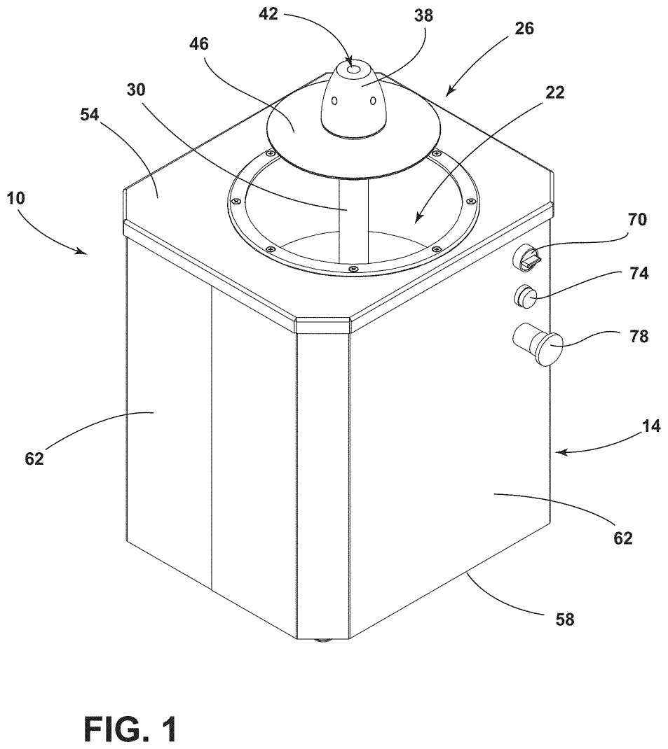

Referring to FIGS. 1, 5 and 21A, reference numeral 10 generally designates a waffle cone coating assembly. The waffle cone coating assembly 10 includes a cabinet 14 defining an interior 18. The cabinet 14 includes a basin 22 and a fountain assembly 26 disposed within the basin 22. The fountain assembly 26 includes a tube 30 having an upper end 34 spaced from the basin 22 and a nozzle 38 disposed at the upper end 34 of the tube 30. The nozzle 38 includes a plurality of coating outlets 42. A flange 46 is disposed below the nozzle 38 and includes a diameter greater than a diameter of the nozzle 38. The waffle cone coating assembly 10 is configured to recirculate a coating material 50 from the basin 22 through the plurality of coating outlets 42 and return the coating material 50 to the basin 22.

While described as a waffle cone coating assembly 10, the waffle cone coating assemblies of the present disclosure can be suitable to coat a variety of cones having a shape and size (e.g., a rolled, conical shape) corresponding to a shape of the nozzles described herein. Therefore, the waffle cone coating assemblies may be cone coating machines that coat a material on an interior surface of cones, which can made from any suitable material or batter, such as cake cones, sugar cones, and the like. Likewise, while described as chocolate throughout the present disclosure, the coating material 50, can be any suitable material or coating fluid, such as caramel, nut butters, icing, and any other compound coating having desired coating characteristics to coat an interior of a cone.

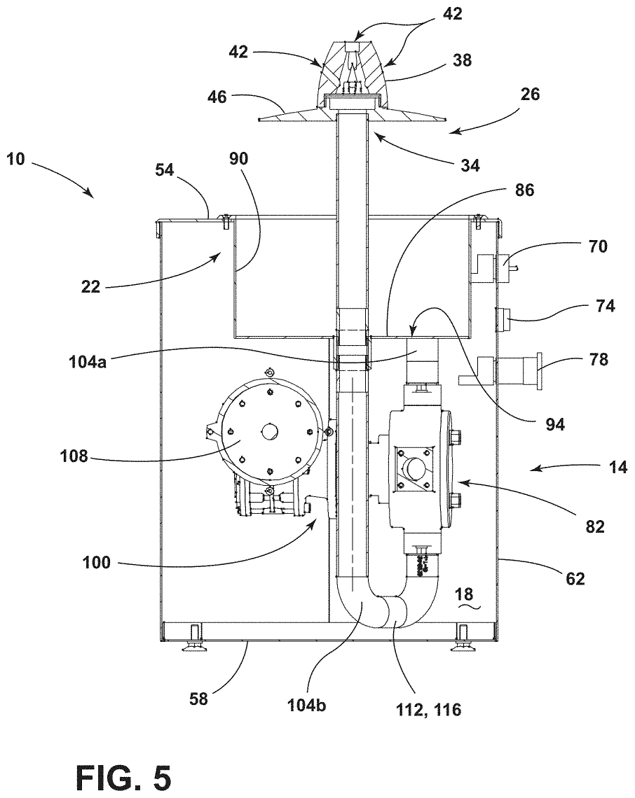

Referring now to FIGS. 1 and 2, the illustrated waffle cone coating assembly 10 includes the cabinet 14 defining the interior 18 (FIG. 5). The cabinet 14 may include a top surface 54 and a bottom surface 58 connected by at least one sidewall 62. The basin 22 is coupled with the top surface 54. As illustrated, an upper ring 66 of the basin 22 is mounted to the top surface 54 such that the basin 22 is disposed substantially below the top surface 54 and extends into the interior 18. In this way, the basin 22 may suspend from the top surface 54. However, the basin 22 may be located in any suitable position, such as above the top surface (e.g., the upper ring 66 is higher than the top surface 54).

The fountain assembly 26 is fluidly coupled to the basin 22 via the tube 30. It is generally contemplated that the tube 30 is removable, which may include a threaded connection coupling the basin 22 and the tube 30. However, the tube 30 may be coupled to the basin 22 in any suitable manner and may be fixed in position. Likewise, the nozzle 38 and flange 46 may be selectively coupled to the tube 30, which is advantageous for cleaning. The tube 30 can include any suitable length, which may depend on dimensions of the cabinet 14. In specific examples, the tube 30 is in a range of approximately 29-36 inches (74-91 cm) or a range of approximately 8-15 inches (20-38 cm). As none of the components of the fountain assembly 26 include a diameter greater than a diameter of the basin 22, the fountain assembly 26 may be disposed within the basin 22.

Thus, coating material 50 that flows from the coating outlets 42 on the nozzle 38, which may further run off and cascade from the flange 46, returns to the basin 22 for collection and recirculation. For example, the nozzle 38 may include a maximum diameter at a base of the nozzle 38 in a range of approximately 2.5-3 inches (6-8 centimeters (cm)), which may include a range of 5-9 cm. The flange 46 may include a maximum diameter of approximately 7.87 inches (in) (20 cm), which may include a range of 10-27.5 cm. The basin 22 may include a diameter of approximately 9.84 in (25 cm), which may include a range of 8-18 in (20.3-45.7 cm) but is not limited to such. In specific examples, the basin 22 includes a diameter, or maximum width, of less than 16.5 in (42 cm). Further, the nozzle 38 is dimensioned to be received within a waffle cone. Therefore, a maximum diameter of the nozzle 38 may be slightly less than a maximum diameter of the waffle cone. In some examples, the nozzle 38 includes a height of approximately 2.8 in (7 cm), which may include a range of 5-9 cm.

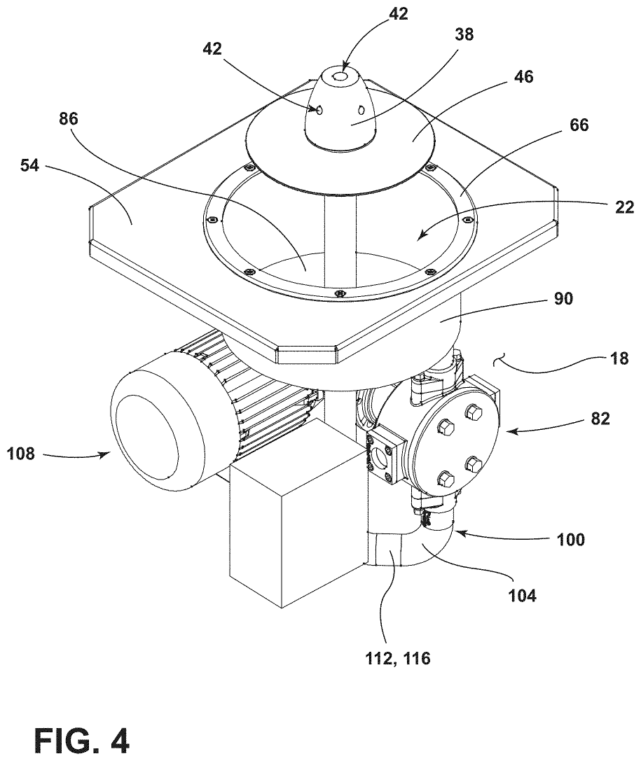

Still referring to FIGS. 1 and 2, the waffle cone coating assembly 10 includes controls for controlling operation of the waffle cone coating assembly 10. In some aspects, the controls include a power control 70, a pump control 74 and a pump speed control 78, but is not limited to these examples. The controls 70, 74, 78 can be in the form of any suitable control device, such as knobs, dials, toggle switches, buttons, and the like. The power control 70 may be configured to activate or deactivate the waffle cone coating assembly 10, which may include delivering or cutting off current to the waffle coating assembly 10. In some examples, using the power control 70 to turn on the waffle cone coating assembly provides current to heating elements of the assembly without additional input from an operator. Likewise, the pump control 74 may be configured to activate a pump 82 (FIG. 4) on or off, during a powered “on” state of the waffle cone coating assembly 10. The pump speed control 78 may be configured to regulate a speed of the pump to adjust the flow of coating material 50 through the coating outlets 42 on the nozzle 38. In some aspects, the pump speed control 78 can adjust the flow rate within a range of approximately 0-12 pounds per minute (approximately 0-0.09 kg/s).

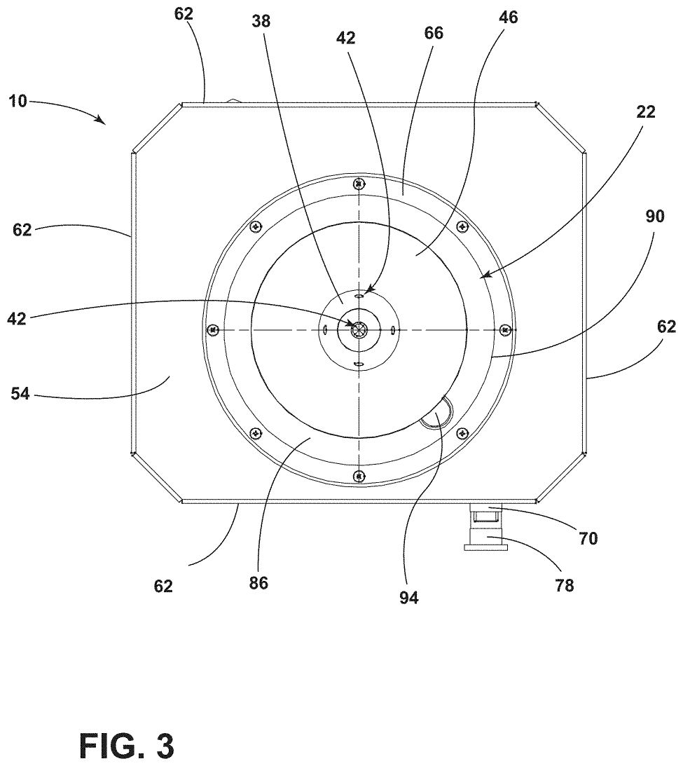

Turning to FIG. 3, a top view of the waffle cone coating assembly 10 is illustrated. As can be seen in FIG. 3, none of the components of the fountain assembly 26 include a diameter greater than a diameter of the basin 22. A diameter of the flange 46 is less than the diameter of the basin 22 by a sufficient difference such that any splatter of the coating material 50 running off of the flange 46 is limited and substantially captured by the basin 22. As illustrated in FIG. 5, the basin 22 includes a bottom surface 86 coupled to the upper ring 66 by an annular sidewall 90. The basin 22 may include a greater width, or diameter, than a depth of the annular sidewall 90. However, the configuration of the basin 22 is not limited to such and may include any suitable configuration for containing, or collecting, the coating material 50. For example, the basin 22 may include a shape other than the shape of the basin illustrated in FIG. 3, such as a spherical “cap” with edges and a bottom surface (e.g., 86) forming a seamless curve (e.g., a bowl shape). In some examples, the basin 22 may retain approximately 10-20 pounds of coating material 50 (e.g., 17 pounds). A drain inlet 94 may be defined by the bottom surface 86 of the basin 22. The basin 22, or any other component of the waffle cone coating assembly 10, may be made of any suitable material, such as stainless steel or copper, but is not limited to such.

Referring now to FIG. 4, the bottom surface 58 and the sidewalls 62 of the cabinet 14 are omitted to more clearly illustrate the interior 18 of the waffle cone coating assembly 10. The waffle cone coating assembly 10 includes a coating material recirculation system 100 including the pump 82, a recirculation conduit 104, and a motor 108 for circulating the coating material 50. However, the configuration of the recirculation system 100 is not limited to such and may include any suitable configuration for recirculating the coating material 50 from the basin 22 through the tube 30, the nozzle 38, the plurality of coating outlets 42, and back to the basin 22. The illustrative pump 82 includes a pump casing in which any suitable pump may be housed. In some examples, the pump 82 is a lobe pump. The motor 108 is configured to drive the pump 82. For example, upon actuating the pump control 74 (e.g., adjusting a dial to an “on” position), the motor 108 may rotate two pumping elements (rotors) within a chamber (pump casing) to draw the coating material 50 from the basin 22, through the drain inlet 94 and supply the coating material to the tube 30 and nozzle 38.

FIG. 5 is a cross-sectional view of the waffle cone coating assembly 10 more clearly illustrating the recirculation system 100. As illustrated, the recirculation conduit 104 may include a plurality of conduits fluidly coupled with the fountain assembly 26 and basin 22, such as a receiving recirculation conduit 104a and a supplying recirculation conduit 104b. The receiving recirculation conduit 104a fluidly couples the drain inlet 94 to the pump 82 while the supplying recirculation conduit 104b fluidly couples the pump 82 to the tube 30. The recirculation system 100 is coupled with at least one heating element 112 configured to heat the coating material 50. In this way, the coating material 50, which may be solid at lower temperatures (e.g., chocolate), can be kept in a liquid state (e.g., at a lower viscosity) within a predetermined temperature range. However, the waffle cone coating assembly 10 may operate to recirculate a variety of coating materials, or coating fluids, such as caramel, nut butters, and any other compound coating with desired coating characteristics. In some examples, the heating element 112 includes a band heater 116. The band heater 116 may be coupled to any suitable surface, which contacts the coating material 50, such as the recirculation conduits 104a, 104b and the basin 22, but is not limited to such locations.

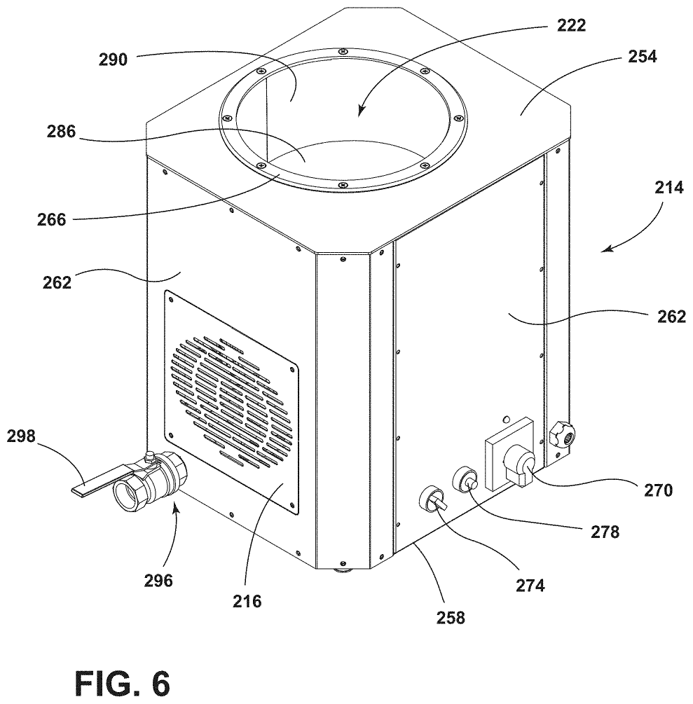

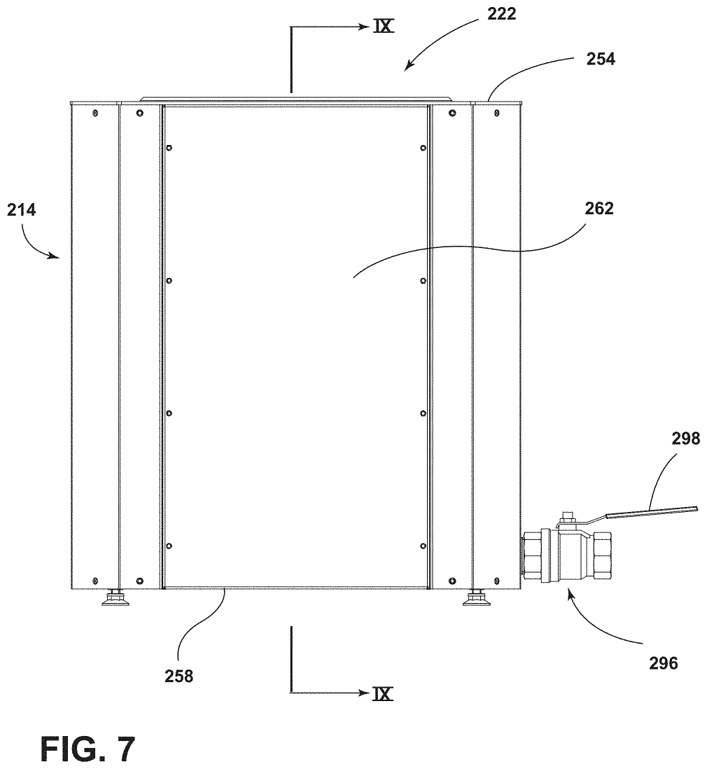

With reference now to FIGS. 6-10, another exemplary cabinet 214 for a waffle cone coating assembly 10 is illustrated. As the cabinet 214 is similar to the cabinet 14, like parts will be numbered with like numerals increasing by 200, unless otherwise indicated. Accordingly, the description with respect to like parts of the cabinet 14 applies to like parts of the cabinet 214, unless otherwise noted. While the cabinet 214 is shown without the fountain assembly 26, the fountain assembly 26 may be coupled to the cabinet 214 according to various aspects described herein to construct the waffle cone coating assembly 10.

Still referring to FIGS. 6-10, the cabinet 214 includes a top surface 254 and a bottom surface 258 connected by at least one sidewall 262. The cabinet 214 may include at least one control panel 216 to access the interior 218 of the cabinet 214. The basin 222 is coupled with the top surface 254. As illustrated, the upper ring 266 of the basin 222 is mounted to the top surface 254 such that the basin 222 is disposed substantially below the top surface 254 and extends into the interior 218. The cabinet 214 includes interface controls for controlling operation of the waffle cone coating assembly 10. In some aspects, the controls include a power control 270, a pump control 274, and a pump speed control 278. Again, the controls 270, 274, 278 may be analog or digital and the interface controls can be in the form of any suitable interface controls, such as knobs, dials, toggle switches, buttons, and the like. The cabinet 214 may include an indicator light 272 configured to illuminate when the waffle cone coating assembly 10 is in the powered “on” state.

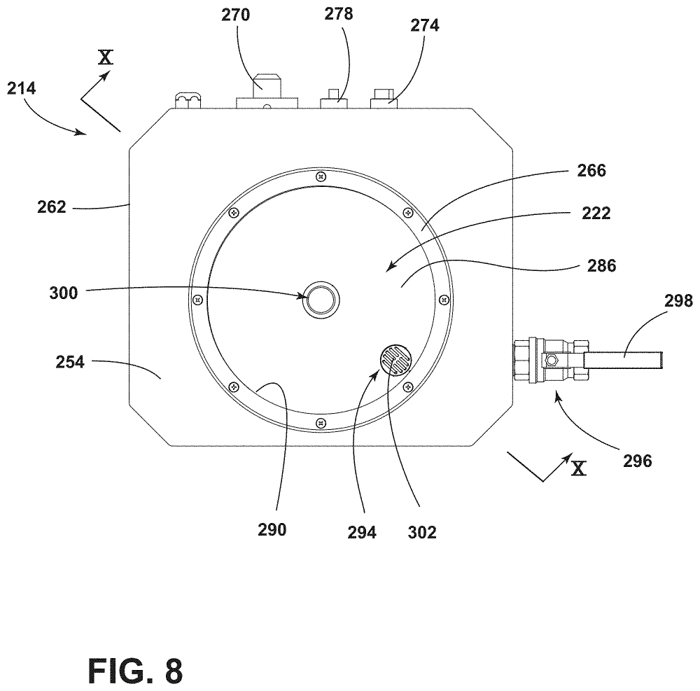

The cabinet 214 includes a drain outlet 296 configured to drain the coating material 50 from recirculation system 300 to an exterior of the cabinet 214. In some examples, the drain outlet 296 includes a lever 298 configured to open and close a valve coupled with the drain outlet 296. In this way, the lever 298 controls the passage of the coating material 50 from the drain outlet 296 to the exterior of the cabinet 214. With reference to FIG. 8, a grate 302 may cover the drain inlet 294 defined by the bottom surface 286 of the basin 222 to prevent larger solids (e.g., pieces of a waffle cone) from entering the recirculation system 300 during circulation of the coating material 50.

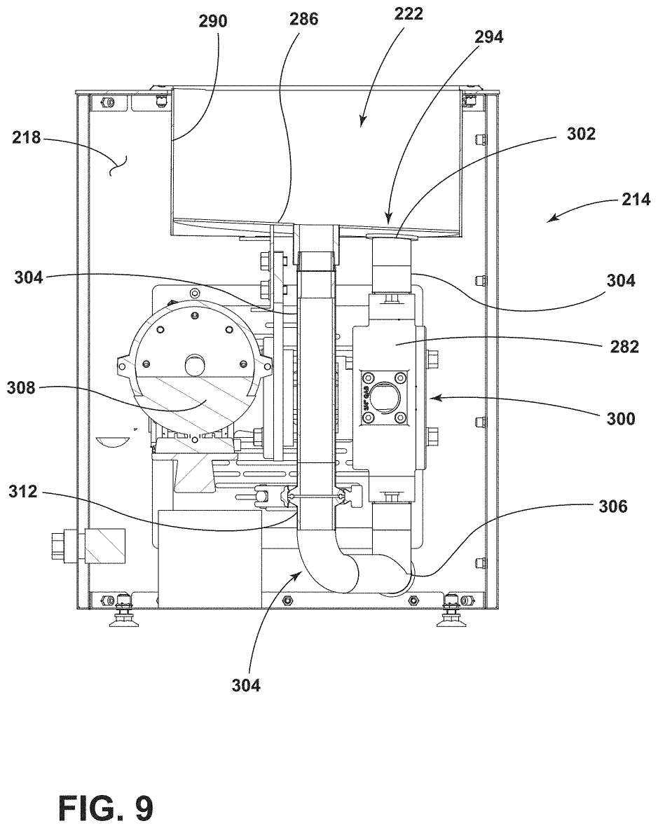

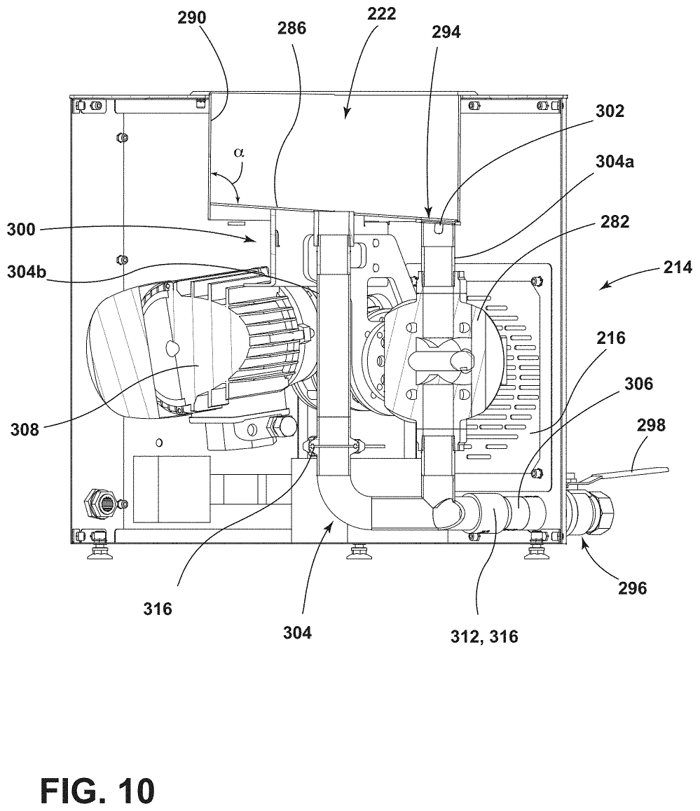

FIGS. 9 and 10 are cross-sectional views of the cabinet 214 more clearly illustrating the recirculation system 300. As illustrated, the recirculation conduit 304 may include a plurality of conduits, fluidly coupled with the fountain assembly 26 and basin 222, such as the receiving recirculation conduit 304a and the supplying recirculation conduit 304b. Further, a drain outlet conduit 306 may be fluidly coupled with the recirculation system 300 (e.g., to the supplying recirculation conduit 304b). The drain outlet 296 is fluidly coupled with the drain outlet conduit 306. The receiving recirculation conduit 304a fluidly couples the drain inlet 294 to the pump 282 while the supplying recirculation conduit 304b fluidly couples the pump 282 to the tube. The recirculation system 300 is coupled with at least one heating element 312 configured to heat the coating material 50.

As illustrated in FIGS. 9 and 10, the bottom surface 286 of the basin 222 is sloped toward the receiving recirculation conduit 304a. Stated another way, an angle, α, between the bottom surface 286 and the sidewall 290 opposite the drain inlet 294 may be greater than 90° and less than 180°. As such, an angle between the bottom surface 286 and the sidewall 290 nearest the drain inlet 294 may be less than 90° and greater than 0°. In this way, coating material 50 can collect on the bottom surface 286 and pool near the drain inlet 294 to facilitate recirculation of the coating material 50 into the receiving recirculation conduit 304a. However, as previously discussed, the with respect to the basin 22, the basin 222 is not limited to such a configuration and may include any suitable configuration to contain, or collect, the coating material 50. For example, the basin 222 may include a shape other than the shape of the basin illustrated in FIG. 3, such a spherical “cap” with edges and a bottom surface (e.g., 86) forming a seamless curve (e.g., a bowl shape).

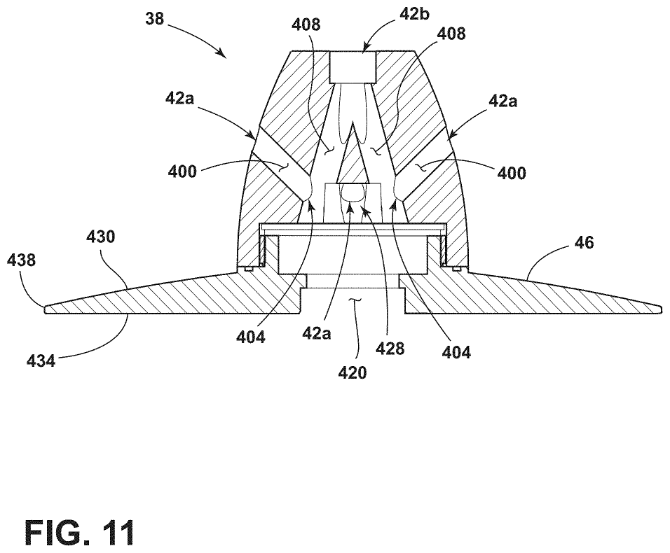

Referring now to FIG. 11, the nozzle 38 and flange 46 are illustrated in more detail. As previously discussed, the nozzle 38 and flange 46 are components of the fountain assembly 26, which may be used in conjunction with a cabinet according to the present disclosure (e.g., cabinets 14, 214) to form the waffle coating assembly 10. The coating outlets 42 may further include side coating outlets 42a and at least one upper coating outlet 42b. The side coating outlets 42a may include an opening diameter of approximately 0.30 in (7.5 mm), which may include a range of 5-15 mm. The upper coating outlet 42b may include an opening diameter greater than the opening diameter of the side coating outlets 42a, which may be approximately 0.59 in (15 mm) to balance a flow of coating material 50 therethrough. Therefore, the upper coating outlet 42b may include an opening diameter in a range of 10-20 mm. The coating outlets 42 are fluidly coupled to the recirculation system 100, 300 to receive the coating material 50.

As illustrated, the nozzle 38 defines side channels 400 fluidly coupled to the side coating outlets 42a. Additionally, the nozzle 38 may define one or more central channels 408 that fluidly couple the side channels 400 and the upper coating outlet 42b. In some examples, the side channels 400 are angled such that the side coating outlets 42a are positioned higher than an interior end 404 of the side channels 400. For example, the side channels 400 may converge at an angle of approximately 120° at the central channels 408.

Still referring to FIG. 11, the flange 46 is coupled with a bottom surface of the nozzle 38. The flange 46 may define a recess 420 configured to selectively receive an upper end of the tube 30. Additionally, a plurality of inlet channels 428 may be disposed within a lower portion of a center of the nozzle 38 to fluidly couple the tube 30 to the central channels 408. In this way, the nozzle 38 can more effectively direct coating material 50 from the tube 30 through the central channels 408. Accordingly, coating material 50 can flow from the tube 30, through the inlet channels 428, the channels 400, 408 and exit the nozzle 38 at the side coating outlets 42a and upper coating outlet 42b.

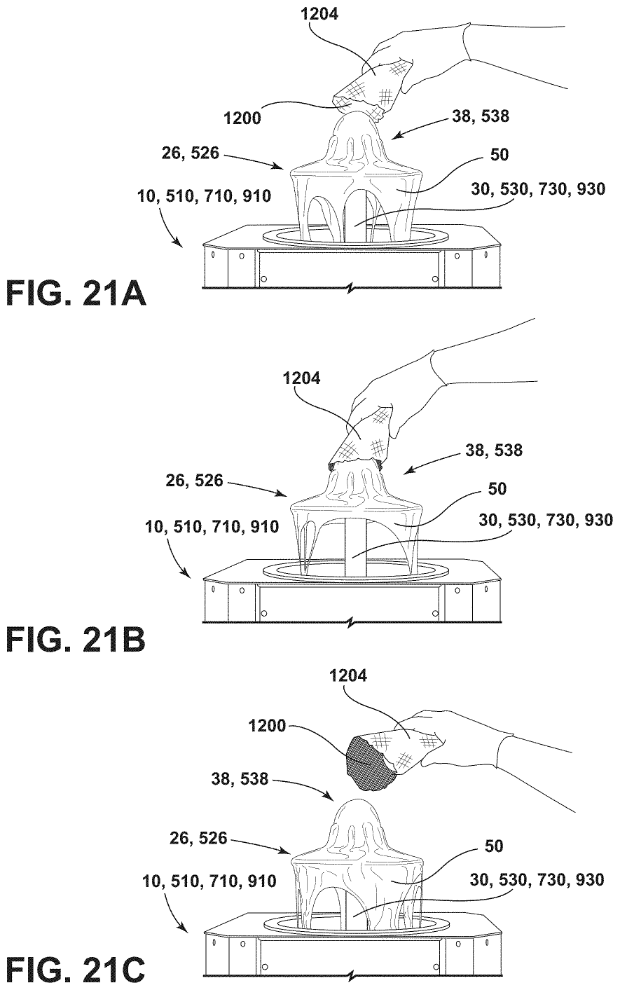

The flange 46 may include an upper surface 430 and a lower surface 434, which intersect at an annular edge 438. A height between the upper surface 430 and the lower surface 434 increases from the annular edge 438 toward the nozzle 38 such that the upper surface 430 includes a downward slope. In some examples, the flange 46 includes a maximum height of approximately 0.59 in (15 mm), which may include a range of 10-20 mm. Accordingly, coating material 50 can run off, or cascade from, the upper surface 430 at a rate which generates a veil effect, as shown in FIGS. 21A-21C.

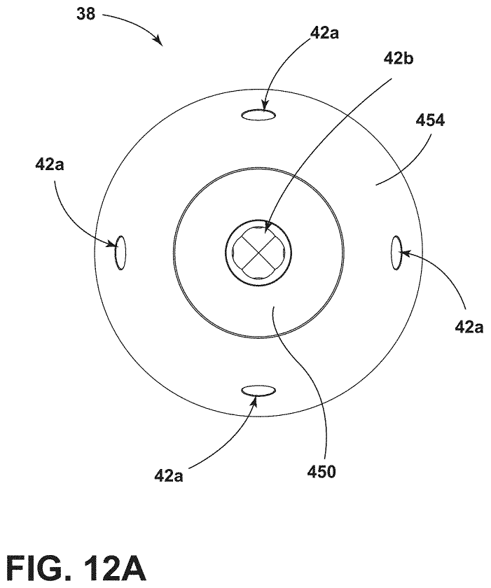

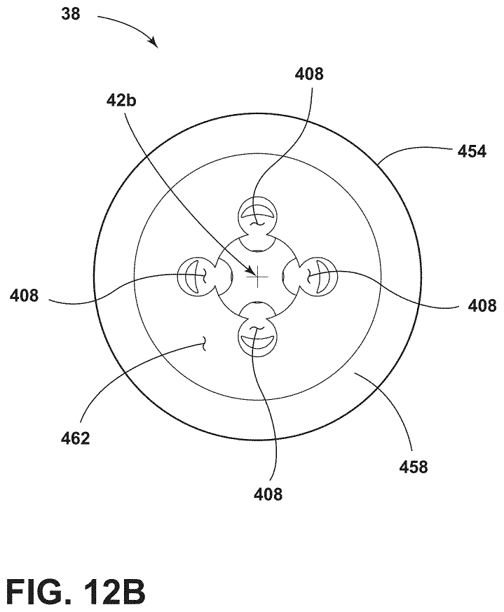

Turning now to FIGS. 12A and 12B, a top view and a bottom view, respectively, of the nozzle 38 for the waffle cone coating assembly 10 is illustrated. As illustrated, an upper surface 450 of the nozzle 38 defines the upper coating outlet 42b, and an annular sidewall 454 of the nozzle 38 defines the side coating outlets 42a. It is generally contemplated that there are four side coating outlets 42a, oriented approximately 90° from each adjacent side coating outlet 42a. However, it is within the scope of the disclosure to use any suitable number and location of side coating outlets 42a. Additionally, a bottom surface 458 (FIG. 12B) may define a recess 462 configured to receive a central extension 466 on the flange 46 to facilitate coupling of the nozzle 38 to the flange 46.

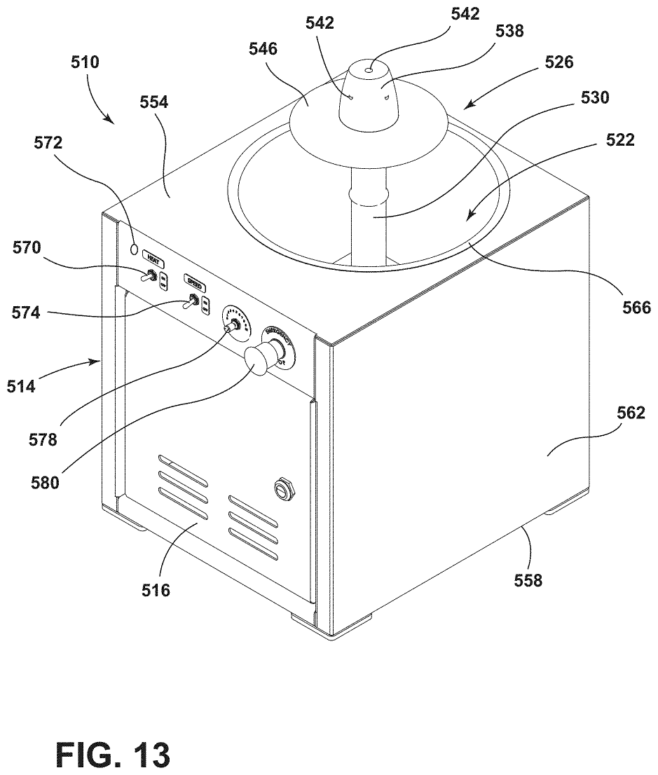

With reference now to FIGS. 13-16, another exemplary waffle cone coating assembly 510 is illustrated. As the waffle cone coating assembly 510 is similar to the waffle cone coating assembly 10, like parts will be numbered with like numerals increasing by 500, unless otherwise indicated. Accordingly, the description with respect to like parts of the waffle cone coating assembly 10 applies to like parts of the waffle cone coating assembly 510, unless otherwise noted.

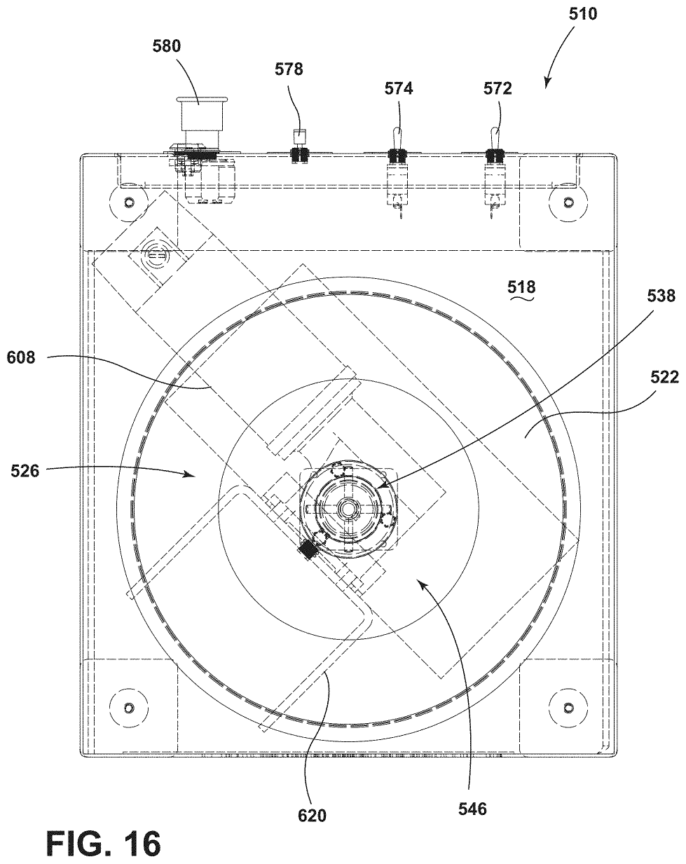

The illustrated waffle cone coating assembly 510 includes a cabinet 514 defining an interior 518 (FIGS. 16-18). The cabinet 514 may include a top surface 554 and a bottom surface 558 connected by at least one sidewall 562. A basin 522 is coupled with the top surface 554. As illustrated, an upper ring 566 of the basin 522 is mounted to the top surface 554 such that the basin 522 is disposed substantially below the top surface 554 and extends into the interior 518. However, the basin 522 may be located in any suitable position, such as above the top surface (e.g., the basin 522 projects from the top surface 54).

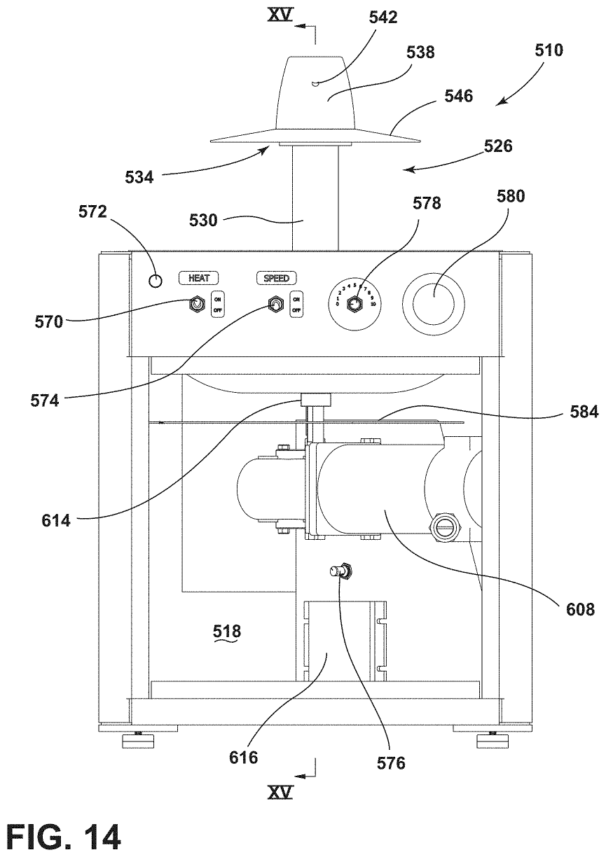

Referring now to FIGS. 13 and 14, a fountain assembly 526 is disposed within the basin 522. The fountain assembly 526 includes a tube 530 having an upper end 534 spaced from the basin 522 and a nozzle 538 disposed at the upper end 534. The fountain assembly 526 is fluidly coupled to the basin 522 via the tube 530. The nozzle 538 includes a plurality of coating outlets 542. A flange 546 is disposed below the nozzle 538 and includes a diameter greater than a diameter of the nozzle 538. The waffle cone coating assembly 510 is configured to recirculate the coating material 50 from the basin 522 through the plurality of coating outlets 542 and return the coating material 50 to the basin 522.

It is contemplated that the tube 530 is removable, which may include a threaded connection coupling the basin 522 and the tube 530, or a press-fit connection, but is not limited to such configurations. Likewise, a nozzle 538 and a flange 546, or skirt, may be selectively coupled to the tube 530, which is advantageous for cleaning. The tube 530 may include any suitable length, which may depend on dimensions of the cabinet 514 and/or basin 522. In specific examples, the tube 530 is in a range of approximately 8-15 inches (20-38 cm). Since none of the components of the fountain assembly 526 include a diameter greater than a diameter of the basin 522, the fountain assembly 526 may be disposed within the basin 522. As such, the coating material 50 that flows from the coating outlets 542 on the nozzle 538, which may further run off, or cascade from, the flange 546, returns to the basin 522 for collection and recirculation. Further, the nozzle 538 is dimensioned to be received within a waffle cone. Therefore, a maximum diameter of the nozzle 538 may be slightly less than a maximum diameter of the waffle cone. In some examples, the nozzle 538 includes a height of approximately 2.8 in (7 cm), which may include a range of 5-9 cm.

Referring to FIG. 14, the waffle cone coating assembly 510 includes interface controls, and the like, for controlling operation of the waffle cone coating assembly 510. In some aspects, the controls include a power control 570, a drive control 574, a temperature control 576, a drive speed control 578, a quick-stop 580, but is not limited to these examples. The controls 570, 574, 576, 578, 580 can be in the form of any suitable control device, such as switches, knobs, dials, buttons, and the like. The controls 570, 574, 576, 578, 580 may be analog or digital, and the like. The cabinet 514 may include an indicator light 572 configured to illuminate when the waffle cone coating assembly 510 is in the powered “on” state.

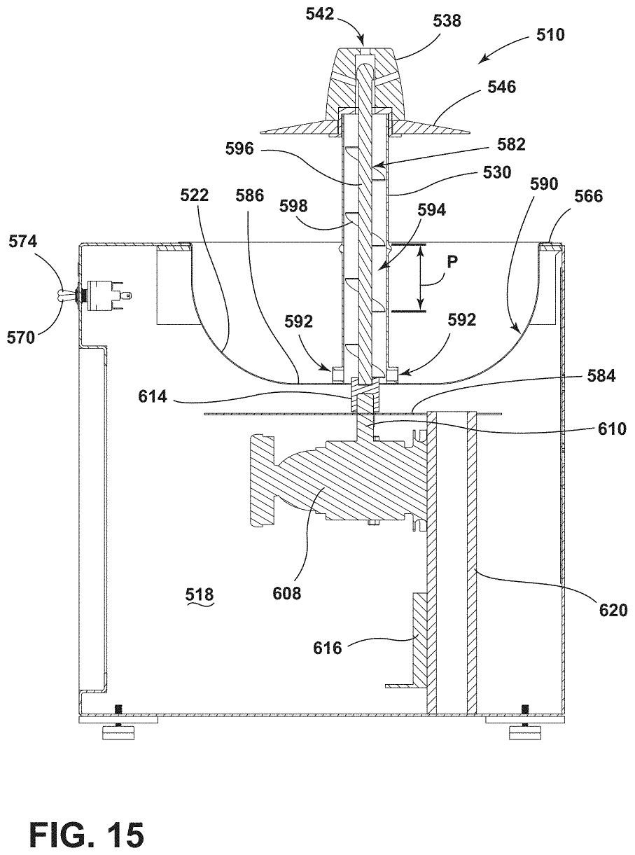

The power control 570 may be configured to activate or deactivate the waffle cone coating assembly 510, which may include delivering or cutting off current to the waffle coating assembly 510. Activating the power control 570 may turn “on” the waffle cone coating assembly 510 to provide current to the various components of the waffle cone coating assembly 510. The drive control 574 may be configured to start or stop driving of an auger 582 (FIG. 15), during a powered “on” state of the waffle cone coating assembly 510. The drive speed control 578 may be configured to regulate a speed of rotation of the auger 582 to adjust a flow rate of the coating material 50 through the coating outlets 542 on the nozzle 538. In some aspects, the drive speed control 578 can adjust the flow rate within a range of approximately 0-12 pounds per minute (approximately 0-0.09 kg/s).

The power control 570 may cause the waffle cone coating assembly to provide current to a heating assembly, which may include a heater/heating element, such as a heating pad 584. In some aspects, the temperature control 576 is disposed within the interior 518 and is configured to adjust the temperature of heating pad 584. The temperature control 576 may be in electrical communication with a thermostat (FIG. 21) to monitor and adjust the temperature. It is contemplated that the heating pad 584 provides heat to the basin 522. For example, the heating pad 584 may be in direct physical contact with the basin 522 to transfer heat to the coating material 50 contained within the basin 522. The coating material 50, which may be solid at lower temperatures (e.g., chocolate), can be kept in a liquid state (e.g., at a lower viscosity) within a predetermined temperature range.

Turning to FIG. 15, the auger 582 may be disposed within the tube 530. Accordingly, the auger 582 is positioned in a vertical arrangement with respect to the basin 522. As illustrated, the basin 522 includes a concave surface 590 having a bottom portion 586. The basin 522 may include a greater width, or diameter, than a depth. However, the configuration of the basin 522 is not limited to such and may include any suitable configuration for containing, or collecting, the coating material 50 (e.g., the shape of basin 22). In some examples, the basin 522 may retain approximately 10-20 pounds of coating material 50 (e.g., 17 pounds). The basin 522, or any other component of the waffle cone coating assembly 510, may be made of any suitable material, such as stainless steel or copper, but is not limited to such.

Still referring to FIG. 15, the auger 582 promotes mixing and blending of the coating material 50 while transferring the material from the basin 522 to the nozzle 538. Indeed, the auger 582 can vertically transfer the delicate coating material 50, which may have a high viscosity, with minimal shear to the material 50. In some aspects the tube 530 may include one or more inlets or feed ports 592 adjacent the bottom 586 of the basin 522. Optionally, the tube 530 may be spaced from the bottom 586 of the basin 522 to form an inlet to the auger 582. Accordingly, the coating material 50 can enter an interior 594 of the tube 530 for transportation to the nozzle 538. The auger 582 can vertically convey, or feed, the coating material. The auger 582 may include a stem 596 and one or more helical, or spiral, flights 598 projecting from the stem. As illustrated in FIG. 15, the auger 582 includes single, or continuous, flight 598. In some aspects, the flight 598 may include a thickness in a range of approximately 1.5-5 millimeters. The auger 582 may include a pitch, P, equal to a diameter of the flight (e.g., full pitch). However, in specific implementations the pitch of the auger 582 may include any suitable dimensions. For examples, the pitch may include two-thirds of the diameter of the flight, or one half of the diameter of the flight (e.g., half pitch), which may be beneficial for vertical transportation of the coating material. In some aspects, the auger 582 may be made of or coated with a food-grade material, such as a food-grade polymer (e.g., polycarbonate or high-density polyethylene) or a food-grade metal (e.g., stainless steel 316).

The auger 582 may be driven by a drive motor 608, thereby forming a coating material recirculation system. In some implementations, the stem 596 is rotatably coupled to a spindle 610 on the drive motor 608. The stem 596 and the spindle a 610 can be coupled via any suitable connection or coupler 614 (e.g., a drive pin). Therefore, the drive motor 608 can drive rotation of the auger 582 to convey the coating material 50 from the basin 522 to the nozzle 538. The drive motor 608 may be any suitable motor configured to rotate the auger 582 (e.g., a gearmotor). As illustrated in FIGS. 14 and 15 a motor speed controller 616 may be provided and in electrical communication with the drive speed control 578 to regulate a speed of the drive motor 608. For example, upon actuating the drive control 574 (e.g., flipping a switch to an “on” position) and positioning the drive speed control 578 at a desired speed, the motor 608 may rotate the auger 582 to draw the coating material 50 from the basin 22, through inlets 592 and supply the coating material 50 to the tube 30 interior 594 and up into the nozzle 538. The illustrative drive motor 608 can be mounted to a stand 620 to fix the position of the drive motor 608 within the interior 518.

Turning to FIG. 16, a top view of the waffle cone coating assembly 510 is illustrated. As can be seen in FIG. 16, none of the components of the fountain assembly 526 include a diameter greater than a diameter of the basin 522. A diameter of the flange 546 is less than the diameter of the basin 522 by a sufficient difference such that any splatter of the coating material 50 running off of the flange 546 is limited and substantially captured by the basin 522. For example, the nozzle 538 may include a maximum diameter at a base of the nozzle 538 in a range of approximately 2.5-3 inches (63.5-76 millimeters), which may include a range of 5-9 cm. The flange 546 may include a maximum diameter of approximately 7.87 in (20 cm), which may include a range of 10-28 cm. The basin 522 may include a diameter of approximately 9.84 in (25 cm), which may include a range of 8-18 in (20.3-45.7 cm) but is not limited to such. In specific examples the basin 522 includes a diameter, or maximum width, of less than 16.5 in (42 cm).

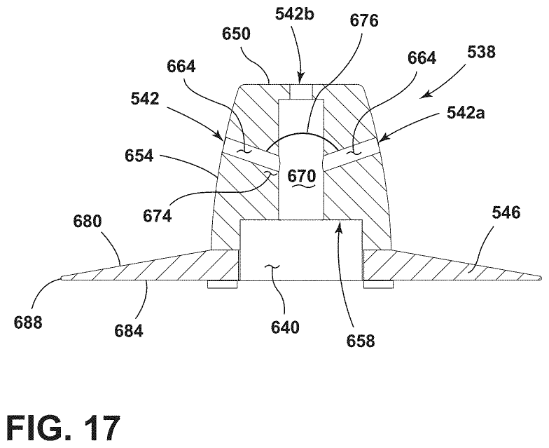

Referring now to FIG. 17, the nozzle 538 is illustrated in more detail. In many ways, the nozzle 538 is similar to the nozzle 38. Accordingly, the description with respect to like parts of the nozzle 38 applies to like parts of the nozzle 538, unless otherwise noted. As previously discussed, the nozzle 538 and flange 546 are components of the fountain assembly 526, which may be used in conjunction with any of the cabinets described herein to form the waffle coating assembly 510. The flange 546 is coupled with a bottom surface of the nozzle 538. The flange 546 may define a recess 640 configured to selectively receive the upper end 534 of the tube 530.

As illustrated, an upper surface 650 of the nozzle 538 defines upper coating outlet 542b, and an annular sidewall 654 of the nozzle 538 defines side coating outlets 542a. It is generally contemplated that there are four side coating outlets 542a, oriented approximately 90° from each adjacent side coating outlet 542a. However, it is within the scope of the disclosure to use any suitable number and location of side coating outlets 542a. The side coating outlets 542a may include an opening diameter of approximately 0.30 in (7.5 mm), which may include a range of 5-15 mm. In some aspects, the upper coating outlet 542b may include an opening diameter greater than the opening diameter of the side coating outlets 542a to balance a flow of coating material 50 therethrough. Specifically, the upper coating outlet 542b may include an opening diameter approximately 0.59 in (15 mm), which may include a range of 10-20 mm. The coating outlets 542 are fluidly coupled to the recirculation system to receive the coating material 50. Additionally, a bottom surface 658 of the nozzle 538 (FIG. 12B) may define a recess 462 configured to receive a central extension 666 on the flange 546 to facilitate coupling of the nozzle 538 to the flange 546.

As illustrated, the nozzle 538 defines side channels 664 fluidly coupled to the side coating outlets 542a. Additionally, the nozzle 538 may define a central bore, or central channel 670 that fluidly couples the side channels 664 and the upper coating outlet 542b. In this way, the side channels 664 intersect with the central channel 670. In some examples, the side channels 664 are angled such that the side coating outlets 542a are positioned higher than an interior end 674 of the side channels 664. For example, the side channels 664 may converge at an angle 676 of approximately 120° with respect to the central channel 670, which may include a range of 80°-160°. The central channel 670 may extend from the bottom 658 of the nozzle 538 to a top of the nozzle 538 to define a continuous conduit with the upper coating outlet 542b. In some aspects, the central channel 670 is sized to receive the upper end 534 of the tube 530 thereby aligning with the stem 596 of the auger 582. Accordingly, the coating material 50 can be conveyed to the side coating outlets 542a and the upper coating outlet 542b from the central channel 670. Specifically, the coating material 50 can flow from the interior 594 of the tube 530 via the auger 582, through the channel 670, the side channels 664 and exit the nozzle 538 at the side coating outlets 542a and upper coating outlet 542b.

The flange 546 may include an upper surface 680 and a lower surface 684, which intersect at an annular edge 688. A height between the upper surface 680 and the lower surface 684 increases from the annular edge 688 toward the nozzle 538 such that the upper surface 680 includes a downward slope. In some examples, the flange 546 includes a maximum height of approximately 0.59 in (15 mm), which may include a range of 10-20 mm. Accordingly, coating material 50 can run off, or cascade from, the upper surface 680 at a rate which generates a veil effect, as shown in FIGS. 21A-21C.

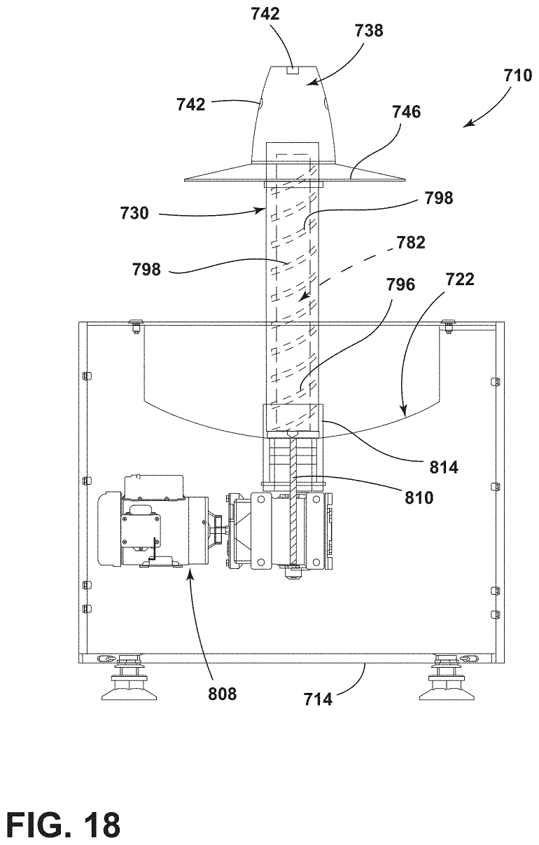

FIG. 18 illustrates another exemplary waffle cone coating assembly 710. As the waffle cone coating assembly 710 is similar to the waffle cone coating assembly 510, like parts will be numbered with like numerals increasing by 200, unless otherwise indicated. Accordingly, the description with respect to like parts of the waffle cone coating assembly 510 applies to like parts of the waffle cone coating assembly 710, unless otherwise noted. One difference in waffle cone coating assembly 710 is the configuration of the auger 782, which includes two flights 798. In this way, the auger 782 may be in the form of a double flight auger. However, the auger 782 as disclosed herein may include any suitable number of flights 798. A pitch of the flights 798 may be equal to a width of one complete helix turn measured parallel to the stem 796. As illustrated in FIG. 18, the auger 782 includes a full pitch (e.g., a pitch equal to a diameter of the flights).

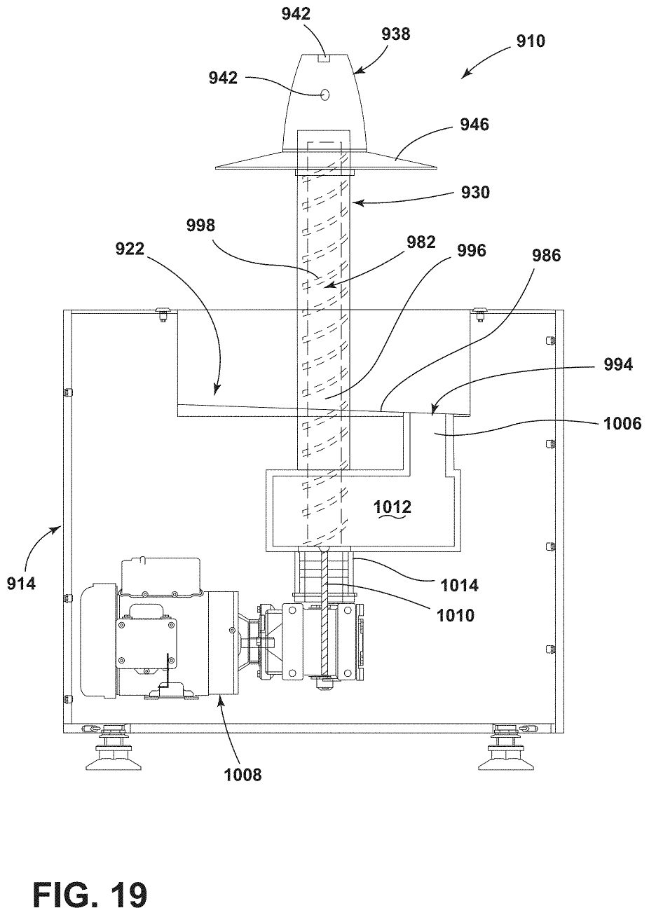

FIG. 19 illustrates another exemplary waffle cone coating assembly 910. As the waffle cone coating assembly 910 is similar to the waffle cone coating assembly 510, like parts will be numbered with like numerals increasing by 400, unless otherwise indicated. Accordingly, the description with respect to like parts of the waffle cone coating assembly 510 applies to like parts of the waffle cone coating assembly 910, unless otherwise noted. One difference in waffle cone coating assembly 910 is the configuration of the basin 922.

As illustrated in FIG. 19, a bottom surface 986 of the basin 922 is sloped toward a drain inlet 994. In this way, the coating material 50 can collect on the bottom surface 986 and pool near the drain inlet 994. The waffle cone coating assembly 910 includes a drain conduit 1006 fluidly coupled to the drain inlet 994. A chamber 1012 is fluidly coupled to the drain conduit 1006 and the auger 982. The chamber 1012 collects the coating material 50 at a bottom end of the auger 982. It is contemplated that the tube 930 may not extend into the chamber 1012 such that the coating material 50 may run into and be picked up by the auger 982. Accordingly, the coating material 50 can enter an interior of the tube 930 for transportation to the nozzle 938. In some aspects, the chamber 1012 and/or the basin 922 may be heated as described herein, or by any suitable technique.

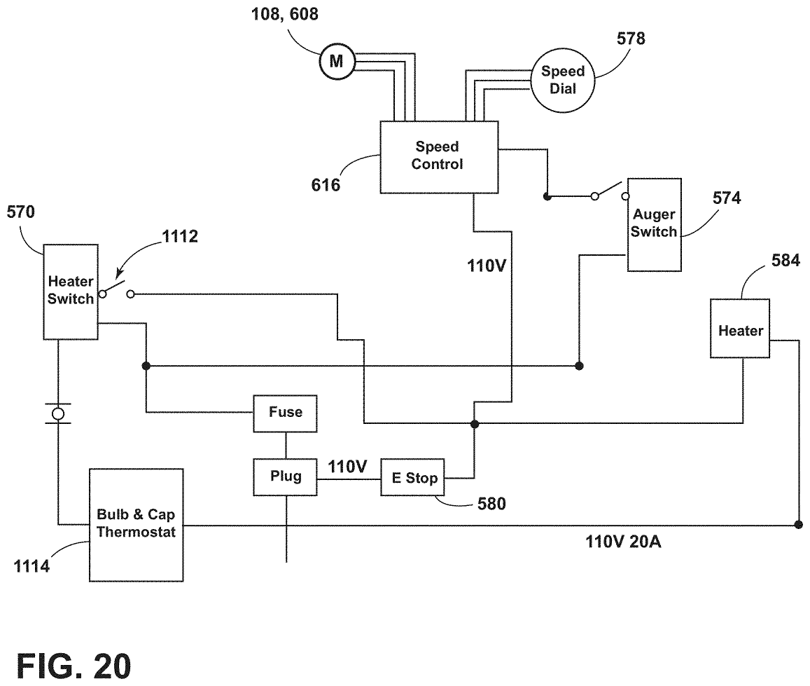

Turning now to FIG. 20, a schematic control diagram 1100 for the waffle cone coating assemblies 10, 510, 710, 910 is illustrated. As previously discussed, the power control 570 may be configured to activate or deactivate the waffle cone coating assembly 510, which may include opening/closing a “power” circuit 1112 for delivering or cutting off current to the waffle coating assembly 510. Closing the power circuit 1112 may turn “on” the waffle cone coating assembly 510 by allowing current to the various components of the waffle cone coating assembly 510. The drive control 574 may be a switch coupled with the speed control 616 and motor 608 to start/stop rotation of the auger 582 (FIG. 15) during a powered “on” state of the waffle cone coating assembly 510. The drive speed control 578 (e.g., a speed dial) may be coupled with the speed control 616 to regulate a speed of rotation of the auger 582. Again, the temperature control 576 may be in electrical communication with a thermostat 1114 to monitor and adjust a temperature of the heater 584 and/or the basin 522. It is contemplated that the heater (e.g., the heating pad 58 provides heat to the basin 522 via direct contact.

To prepare the waffle cone coating assemblies 10, 510, 710, 910 for operation, an operator may actuate the power control 70, 270 to a place the assembly 10, 510, 710, 910 in a powered “on” state. In the powered “on” state, the heating element(s) 112, 312, 584 receive current and provide heat to the components (e.g., recirculation conduit 104, 204, basin 522) in contact with the heating element(s) 112, 312, 584. In this way, the coating material 50, which may be chocolate, disposed within the basin 22, 522 increases in temperature to melt, or reach a desired viscosity.

In some examples, the desired viscosity of the coating material 50 is in a range of approximately 95-115 degrees MacMichael (°McM) (approximately 2.8-3.38 Ns/m²) when heated to the desired temperature. In some examples, the desired temperature of coating material 50 is in a range of approximately 104-120° F. (40.0-48.9° C.), or more specifically in a range of approximately 115-117° F. (46.1-47.2° C.). Once the waffle cone coating assembly 10, 510, 710, 910 is heated sufficiently to liquefy the coating material 50, the pump, 82, 282 or motor 608, may be switched to the “on” state via the pump control 74, 274 or drive control 574, respectively. Next, the pump speed control 78, 278 or the drive speed control 578 may be adjusted to gradually increase the speed of the pump 82, 282 or motor 608, respectively, until a desired flow rate of the coating material 50 through the nozzle 38, 538 is reached. In some aspects, the flow rate of the coating material 50 can be varied from 0 to approximately 12 pounds per minute. The fountain assembly 26, 526 is specifically configured to gently envelop the nozzle 38, 538 with the coating material 50 at the desired flow rate of the coating material 50 such that the coating material 50 is prevented from spraying and the coating material 50 covers substantially an entire outer surface of the nozzle 38, 538. In this way, the nozzle 38, 538 may spread the coating material 50 over the upper surface 450 and the annular sidewall 454 of the nozzle 38.

FIGS. 21A-21C illustrate an exemplary method of coating an interior 1200 of a waffle cone 1204 using the waffle cone coating assemblies 10, 510, 710, 910 once the waffle cone coating assembly 10, 510, 710, 910 is prepared for operation and “up and running”. In some aspects, the waffle cone 1204 is approximately 2.5-3 in (6.35-7.62 cm) in diameter and approximately 6-7 in (15.2-17.8 cm) tall measured from a bottom of the waffle cone 1204 to an upper edge of the waffle cone 1204. However, these dimensions are only exemplary and may include any suitable dimension or shape (e.g., oblong) of waffle cone 1204 configured to be placed onto the nozzle 38, 538.

With reference to FIG. 21A, an operator may begin by placing the interior 1200 of the waffle cone 1204 onto the nozzle 38, 538. Stated another way, an operator may turn the waffle cone 1204 upside down and hold it above the nozzle 38, 538. Then, the waffle cone 1204 is lowered into the nozzle 38, 538 such that the nozzle 38, 538 is positioned substantially inside the waffle cone 1204.

With reference now to FIG. 21B, the operator may then roll the interior 1200 of the waffle cone 1204 into contact with the coating material 50 to coat the interior 1200 of the waffle cone 1204 with the coating material 50. In some examples, the operator may rotate the waffle cone 1204 on an angle for effective coating.

Then, and with reference to FIG. 21C, the operator may remove the waffle cone 1204 from the nozzle 38, 538. Finally, the interior 1200 of the waffle cone 1204 is coated with liquid, warm coating material 50, and the waffle cone 1204 can be oriented right side up (e.g., the narrow-most portion of the waffle cone 1204 is below an opening thereof). In specific examples, approximately 2.5-3 inches (6.35-7.62 cm) of the interior 1200 of the waffle cone 1204 is coated in the coating material 50. Optionally, the waffle cone 1204 may then be filled with ice cream.

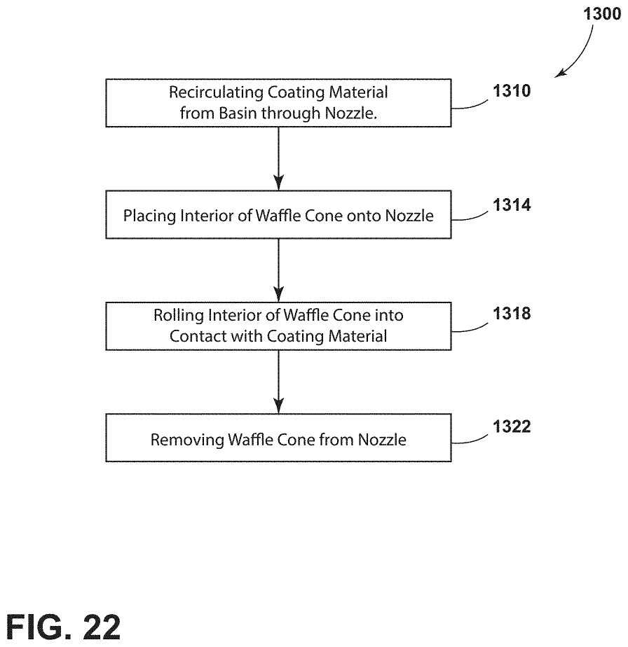

FIG. 22 is a flow diagram of a method 1300 of coating the interior of the waffle cone. The method 1300 may begin at a step 1310 including recirculating the coating material from the basin through the nozzle having the plurality of coating outlets. Step 1310 is performed at a flow rate of coating material that is configured to envelop the nozzle with the coating material. Stated another way, the coating material exits the plurality of coating outlets at a flow rate configured to envelop the nozzle with the coating material such that the nozzle is covered with the coating material. As previously discussed, the nozzle is dimensioned to be received within the waffle cone. Next, at step 1314, the method 1300 may include placing the interior of the waffle cone onto the nozzle. At step 1318, the method 1300 includes rolling the interior of the waffle cone into contact with the coating material to coat the interior of the waffle cone with the coating material. In a last step, the method 1300 may include removing the waffle cone from the nozzle at step 1322.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. A waffle cone coating assembly, comprising:
a cabinet defining an interior and including a basin; and
a fountain assembly disposed within the basin, the fountain assembly comprising:
a tube having an upper end spaced from the basin;
a nozzle disposed at the upper end of the tube, wherein the nozzle includes a plurality of coating outlets; and
a flange disposed below the nozzle, the flange having a diameter greater than a diameter of the nozzle, wherein the waffle cone coating assembly is configured to recirculate a coating material from the basin through the plurality of coating outlets and return the coating material to the basin.

2. The waffle cone coating assembly of claim 1, wherein the coating material exits the plurality of coating outlets at a flow rate configured to envelop the nozzle with the coating material.

3. The waffle cone coating assembly of claim 1, wherein the plurality of coating outlets further comprise:
a plurality of side coating outlets; and
an upper coating outlet.

4. The waffle cone coating assembly of claim 3, wherein an opening diameter of the upper coating outlet is greater than an opening diameter of the plurality of side coating outlets.

5. The waffle cone coating assembly of claim 3, wherein the nozzle defines a plurality of side channels that fluidly couple the side coating outlets to a central channel.

6. The waffle cone coating assembly of claim 5, wherein the tube is fluidly coupled to the central channel.

7. A cone coating machine, comprising:
a basin configured to contain a liquid, the basin including a lower interior surface; and
a fountain assembly disposed within the basin, the fountain assembly comprising:
a tube having an upper end and a lower end, the lower end proximate the lower interior surface of the basin; and
a nozzle coupled to the upper end of the tube, wherein the nozzle includes a plurality of coating outlets, further wherein the cone coating machine is configured to recirculate a coating material from the basin through the plurality of coating outlets and return the coating material to the basin.

8. The cone coating machine of claim 7, wherein the basin includes a greater width than depth.

9. The cone coating machine of claim 7, wherein the plurality of coating outlets are configured to spread the coating material over an upper surface and an annular sidewall of the nozzle.

10. The cone coating machine of claim 7, wherein the plurality of coating outlets further comprise:
a plurality of side coating outlets; and
an upper coating outlet.

11. The cone coating machine of claim 10, wherein an opening diameter of the upper coating outlet is greater than an opening diameter of the plurality of side coating outlets.

12. The cone coating machine of claim 10, wherein the nozzle defines a plurality of side channels that fluidly couple the side coating outlets to a central channel.

13. The cone coating machine of claim 12, wherein the side channels are angled such that the plurality of side coating outlets are positioned higher than an interior end of the side channels.

14. The cone coating machine of claim 12, wherein the tube is fluidly coupled to the central channel.

15. The cone coating machine of claim 7, further comprising:
a flange disposed below the nozzle, the flange having a diameter greater than a diameter of the nozzle.

16. The cone coating machine of claim 15, wherein the flange comprises an upper surface having a downward slope configured to generate a veil effect when the coating material cascades from the flange.

17. A waffle cone coating nozzle assembly, comprising:
a nozzle comprising:
an annular sidewall defining a plurality of side coating outlets;
an upper surface defining at least one upper coating outlet;
a central channel fluidly coupled to the plurality of side coating outlets;
a plurality of side channels that fluidly couple the side coating outlets to at least one central channel, wherein the plurality of side coating outlets are positioned higher than an interior end of the plurality of side channels; and
a flange coupled with a bottom surface of the nozzle, the flange having a diameter greater than a diameter of the nozzle.

18. The waffle cone coating nozzle assembly of claim 17, wherein the flange comprises an upper surface having a downward slope that is configured to generate a veil effect when a coating material cascades from the flange.

19. The waffle cone coating nozzle assembly of claim 17, wherein the nozzle is dimensioned to be received within a waffle cone and includes a maximum diameter at a base of the nozzle in a range of 50-90 millimeters.

20. The waffle cone coating nozzle assembly of claim 17, wherein the central channel is fluidly coupled to a coating material recirculation system.
